(19) United States
(12) Patent Application Publication
(10) Pub. No.: US 2024/0098706 A1
(43) Pub. Date: Mar. 21, 2024

(54) OUT OF ORDER PAGE DECODING FOR IDLE DISCONTINUOUS RECEPTION

(71) Applicant: QUALCOMM Incorporated, San Diego, CA (US)

(72) Inventors: Gowrisankar SOMICHETTY, Bangalore (IN); Fnu SHAT PRATEEK, Agra (IN); Saisruthi KOTAMRAJU, Bengaluru (IN); Harshal Jayesh SHAH, Ahmedabad (IN); Deeptanshu SHUKLA, Bangalore (IN); Carsten Aagaard PEDERSEN, Bolton, MA (US); Murali MENON, Acton, MA (US); Hong ZHANG, Acton, MA (US); Ansuman ADHIKARY, Hyderabad (IN)

(21) Appl. No.: 17/933,329

(22) Filed: Sep. 19, 2022

(51) Int. Cl. H04W 72/04; H04W 68/00; H04W 74/08

(52) U.S. Cl. CPC H04W 72/044; H04W 68/00; H04W 74/0833

(57) ABSTRACT

An apparatus may be provided that is configured to obtain a set of samples associated with a paging occasion (PO). The apparatus may further be configured to process at least one reference signal indicating time and frequency information. The apparatus may also be configured to process the set of samples associated with the PO based on the time and frequency information. The apparatus may be configured to adjust, based on processing the set of samples associated with the PO, a current mode of operation in a set of modes of operation for the wireless device.

### TECHNICAL FIELD

The present disclosure relates generally to communication systems, and more particularly, to decoding a page in an idle and/or discontinuous reception mode of operation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to obtain a set of samples associated with a paging occasion (PO). The apparatus may further be configured to process at least one reference signal indicating time and frequency information. The apparatus may also be configured to process the set of samples associated with the PO based on the time and frequency information. The apparatus may be configured to adjust, based on processing the set of samples associated with the PO, a current mode of operation in a set of modes of operation for the wireless device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating timing for different power saving and communication modes associated with different transmitted signals for an online mode of operation in which tasks are processed in the order in which they are received.

FIG. 5 is a set of diagrams illustrating timing for different power saving and communication modes for a UE associated with different non-overlapping transmitted signals for an offline processing mode of operation.

FIG. 6 is a set of diagrams illustrating timing for different power saving and communication modes for a UE associated with different overlapping transmitted signals for an offline processing mode of operation.

FIG. 7 is a call flow diagram illustrating communication between a base station and a UE in a deep sleep and/or idle mode and a set of operations of the UE to process samples associated with a page in accordance with some aspects of the disclosure.

FIG. 8 is a call flow diagram illustrating communication between a base station and a UE in a deep sleep and/or idle mode and a set of operations of the UE to process samples associated with a page in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an apparatus.

### DETAILED DESCRIPTION

In some aspects of wireless communication, a wireless communication device (e.g., a UE) may be in a power-saving mode (e.g., an idle mode such as RRC IDLE mode, or a “deep sleep”). The power saving mode may be associated with a reduced set of activated and/or a reduced set of active functions. While in the power saving mode, the activated and/or active functions of the wireless communication device may not allow the wireless communication device to receive communication from a transmitting device. Accordingly, the wireless communication device may periodically activate additional functions (e.g., perform a wake up) to detect upcoming communications. The additional functions may be associated with search, measurements, and/or loops processing for processing the reference signal and/or to decode a page associated with a PO. For example, the additional functions may be associated with a set of one or more reference signals used to acquire timing information for a subsequent PO for the wireless communication device that indicates whether a communication is scheduled before a next PO for the wireless communication device.

A method or apparatus may be provided that improves power saving for page occasion decoding in a DRX mode of operation. The improvement may be provided by introducing an offline mode for PO decoding in which a closest-in-time RS may be used to acquire timing and/or frequency information for a PO and samples associated with the RS and the PO may be stored for offline processing. The offline processing may allow a wireless device to increase a fraction of time spent in modes of operations that conserve more power (e.g., deep sleep instead of light sleep or active communication).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

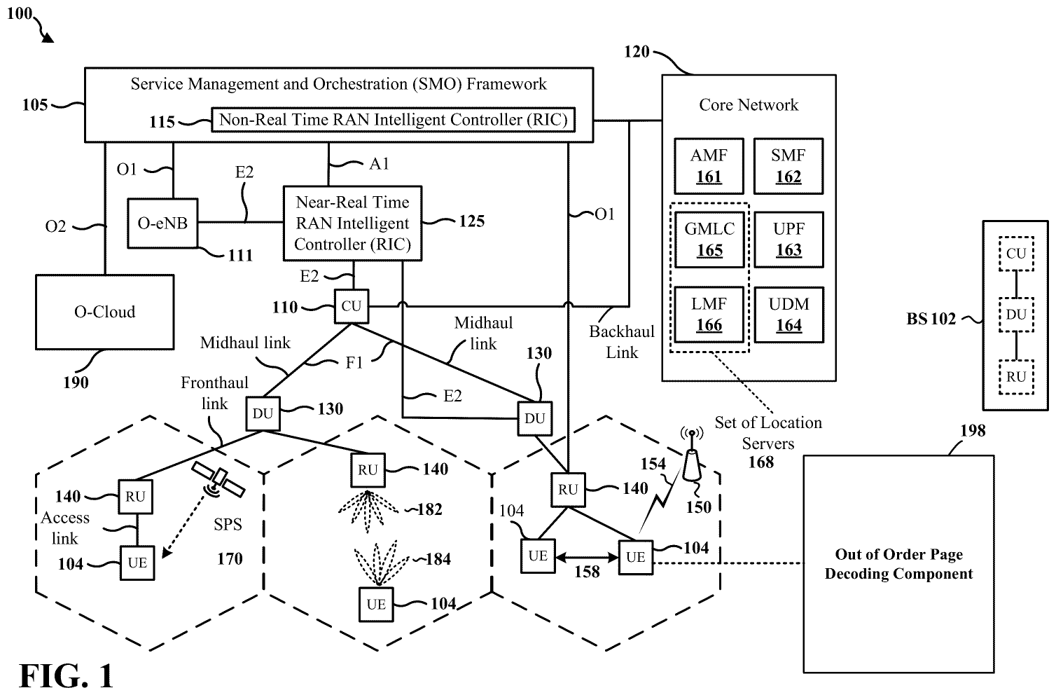

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an out of order page decoding component 198 that may be configured to obtain a set of samples associated with a paging occasion (PO). PO may refer to a paging occasion or a page occasion. The out of order page decoding component 198 may further be configured to process at least one reference signal indicating time and frequency information. The out of order page decoding component 198 may also be configured to process the set of samples associated with the PO based on the time and frequency information. The out of order page decoding component 198 may be configured to adjust, based on processing the set of samples associated with the PO, a current mode of operation in a set of modes of operation for the wireless device. Although the following description may be focused on 5G NR, the concepts described herein may be applicable to other similar areas, such as LTE, LTE-A, CDMA, GSM, and other wireless technologies.

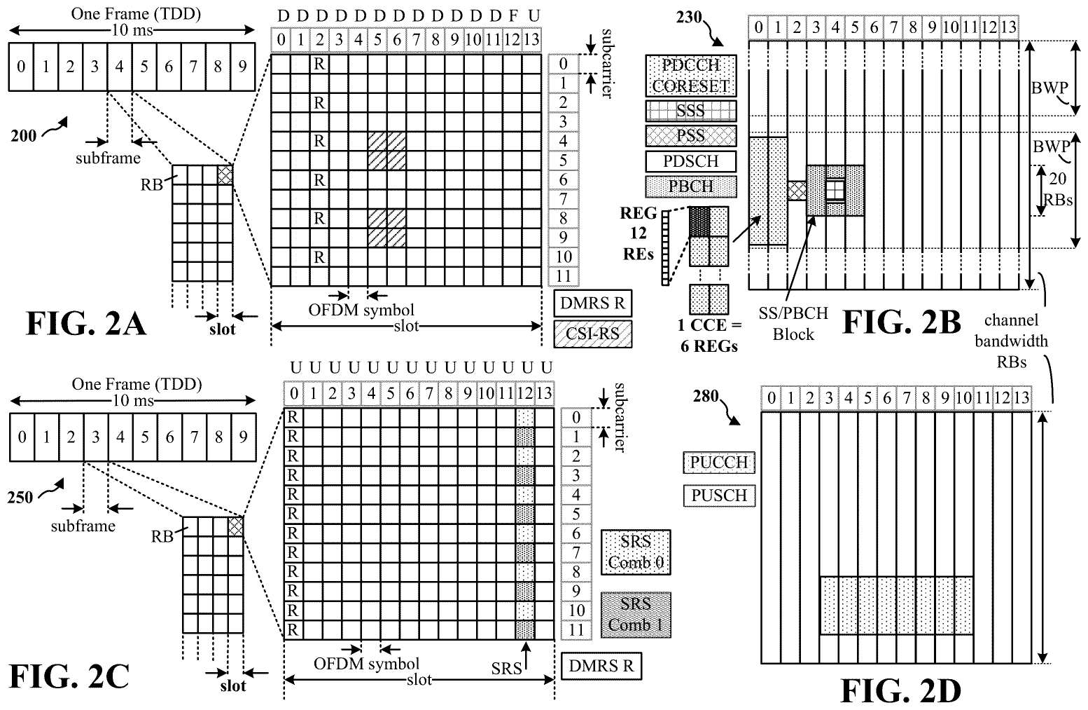

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2μ slots/subframe. The subcarrier spacing may be equal to 2μ*15 kHz, where μ is the numerology 0 to 4. As such, the numerology μ=0 has a subcarrier spacing of 15 kHz and the numerology 1.1=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

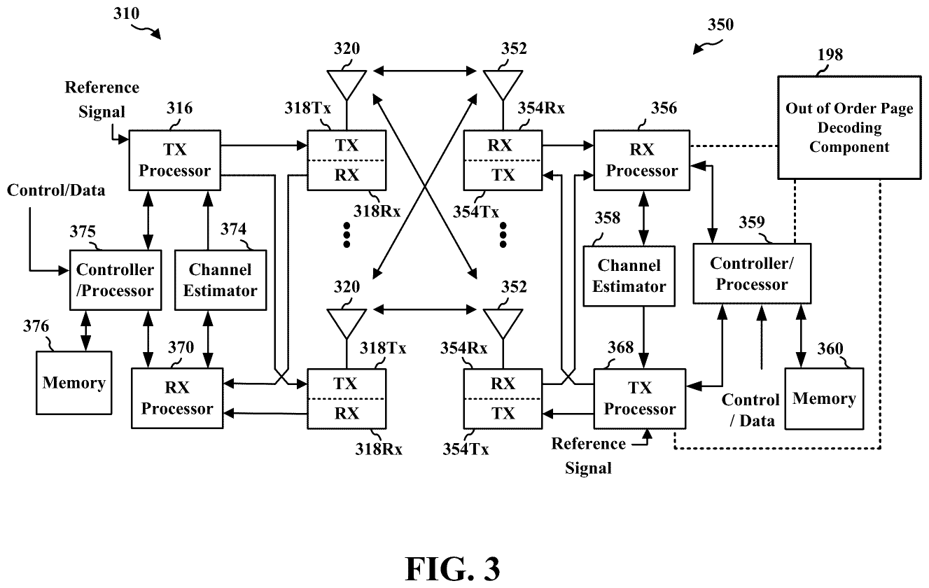

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the out of order page decoding component 198 of FIG. 1.

In some aspects of wireless communication, a wireless communication device (e.g., a UE) may be in a power-saving mode (e.g., an idle mode such as RRC IDLE mode, or a “deep sleep”). The power saving mode may be associated with a reduced set of activated and/or a reduced set of active functions. While in the power saving mode, the activated and/or active functions of the wireless communication device may not allow the wireless communication device to receive communication from a transmitting device. Accordingly, the wireless communication device may periodically activate additional functions (e.g., perform a wake up) to detect upcoming communications. The additional functions may be associated with search, measurements, and/or loops processing for processing the reference signal and/or to decode a page associated with a PO. For example, the additional functions may be associated with a set of one or more reference signals used to acquire timing information for a subsequent PO for the wireless communication device that indicates whether a communication is scheduled before a next PO for the wireless communication device.

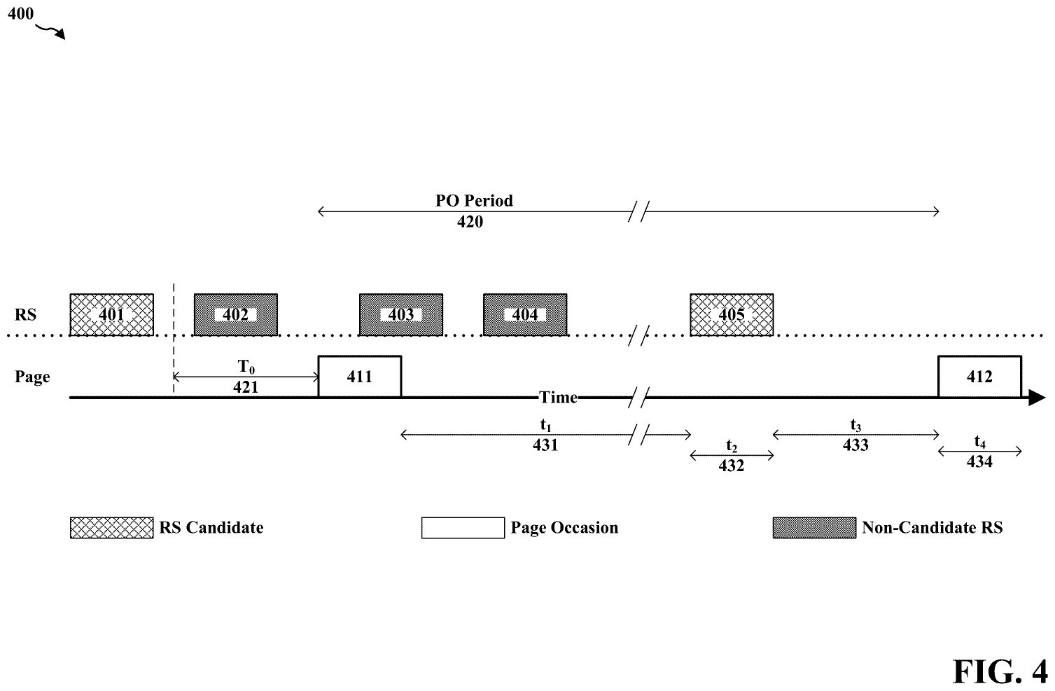

FIG. 4 is a diagram 400 illustrating timing for different power saving and communication modes associated with different transmitted signals for an online mode of operation in which tasks are processed in the order in which they are received (e.g., in an over the air (OTA) order). For example, a transmitter may periodically transmit a set of reference signals (e.g., SSBs or tracking reference signals (TRSs)) including reference signal 401, reference signal 402, reference signal 403, reference signal 404, reference signal 405 (where reference signal 405 may be a reference signal corresponding to reference signal 401 in a subsequent period). The transmitter may also periodically (e.g., with a period, PO period 420) transmit a PO (e.g., PO 411 or PO 412) for the wireless communication device in a plurality of POs for a plurality of wireless communication devices.

In order to allow for a reference signal to be processed to acquire the timing and frequency information used to process the PO, some aspects identify a reference signal that precedes the PO by at least a processing time T₀ 421. Accordingly, reference signals 401 and 405 are identified as candidates for acquiring the timing and frequency information while reference signal 402, reference signal 403, and reference signal 404 are not identified as candidates. After processing PO 411, the wireless communication device may determine that no communication is scheduled before the next PO. Based on the determination, the wireless communication device may deactivate a set of functions associated with receiving and processing the PO 411 and initiate a second power-saving mode (e.g., a deep sleep mode) during a time period t₁ 431. During time period t₂ 432, the wireless communication device may activate a first set of functions for receiving and processing the reference signal 405. The processing may continue during a time period t₃ 433 between the reception of the RS and the reception of the PO 412 during which some communication functions in the first set of functions activated during time period t₂ 432 are deactivated. During a time period t₄ 434, the wireless communication device may activate a second set of functions for receiving and processing the PO. In some aspects, the processing of the PO (e.g., processing samples received during, or associated with, the PO) may take place during the time period t₁ 431.

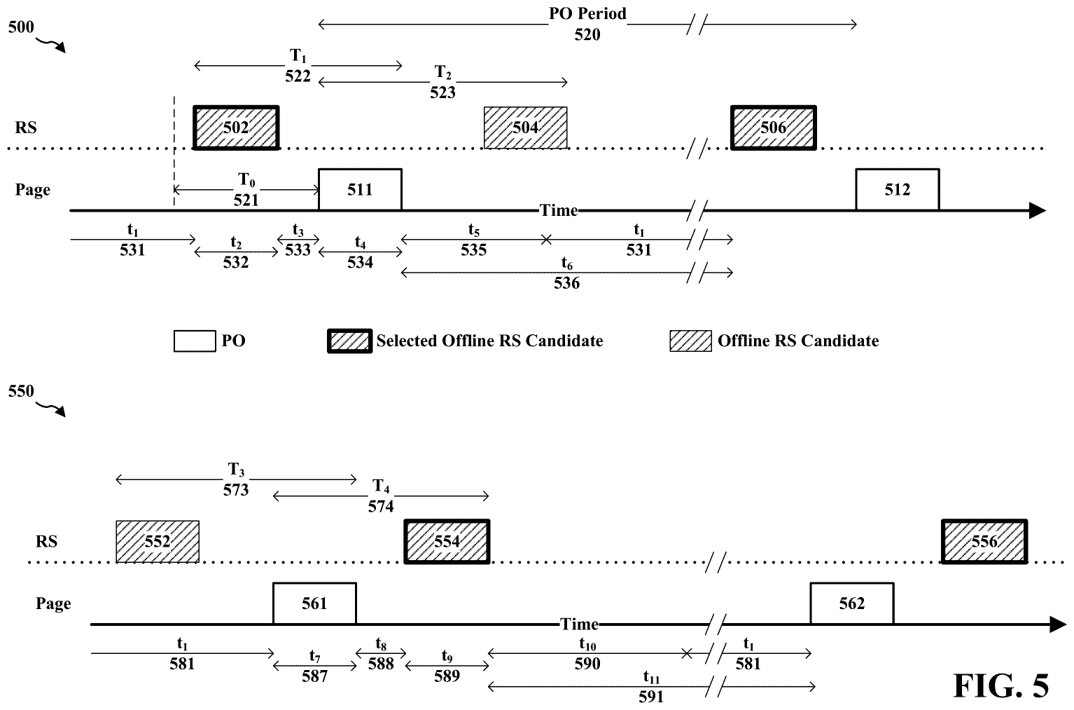

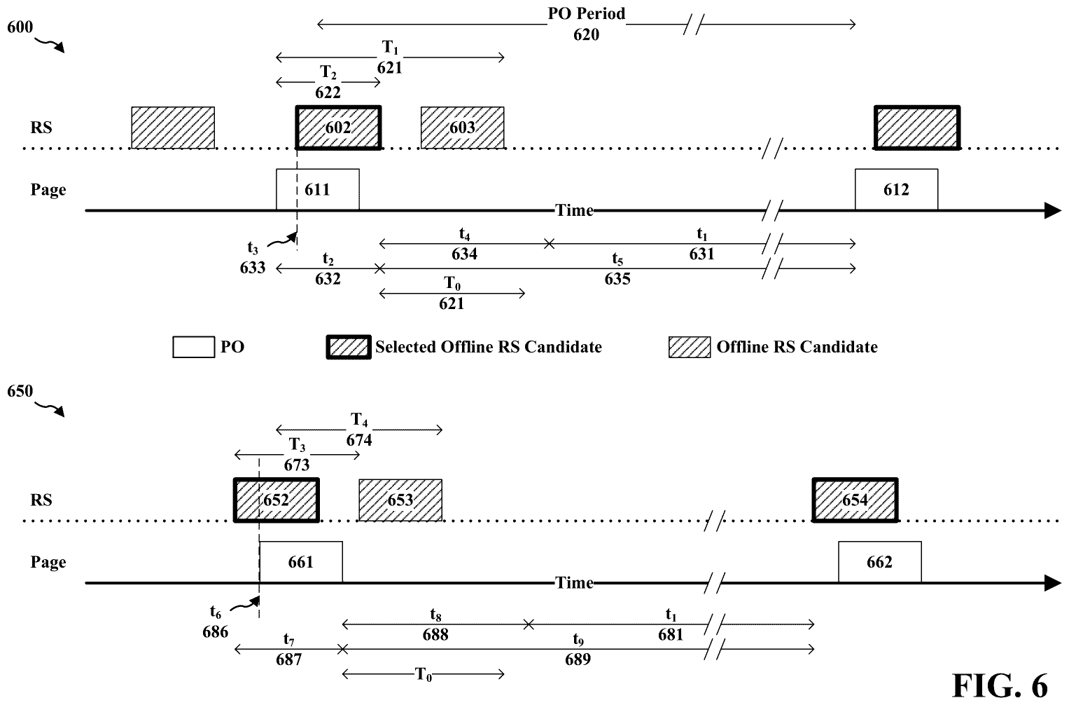

FIG. 5 is a set of diagrams 500 and 550 illustrating timing for different power saving and communication modes for a UE associated with different non-overlapping transmitted signals for an offline processing mode of operation. FIG. 6 is a set of diagrams 600 and 650 illustrating timing for different power saving and communication modes for a UE associated with different overlapping transmitted signals for an offline processing mode of operation. Diagrams 500, 550, 600, and 650 illustrate that a closest RS (e.g., RS 502, RS 554, 602 and/or RS 652) to a PO (e.g., PO 511, 561, 611 and/or PO 661, respectively) may be processed to acquire the timing and frequency information used to process the PO. The RS processed to acquire the timing and frequency information, in some aspects, may be within a processing time T₀ 521 of the PO (e.g., RS 502 may be within the processing time of PO 511). In some aspects, the RS may overlap with and/or follow a PO (e.g., RS 552 follows PO 561, and RS 602 and 652 overlap with PO 611 and 661 respectively).

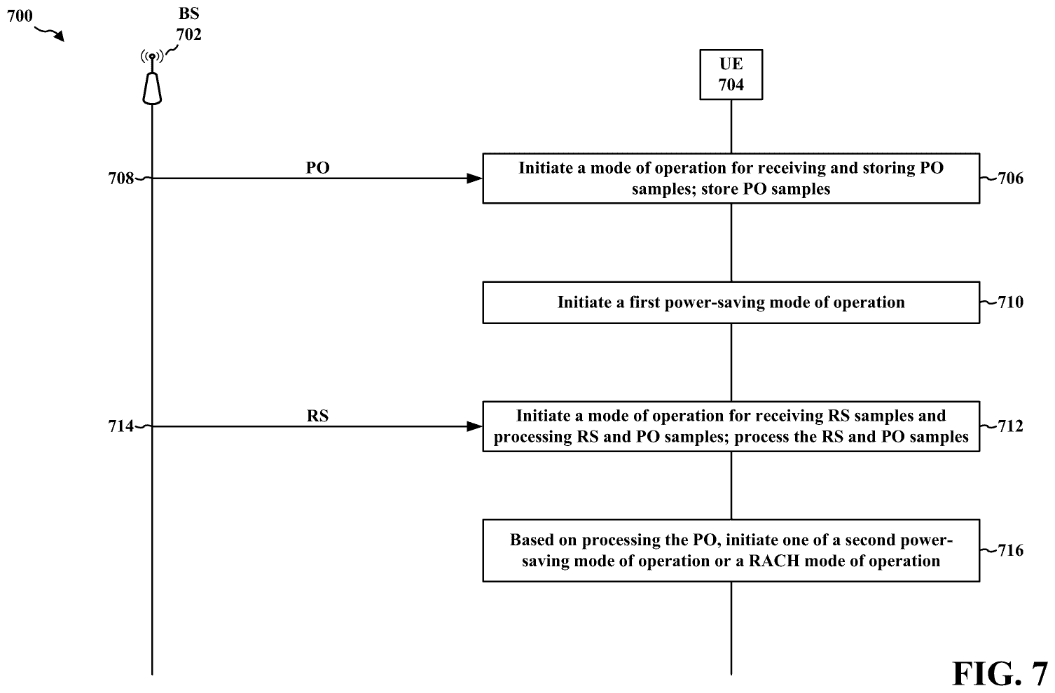

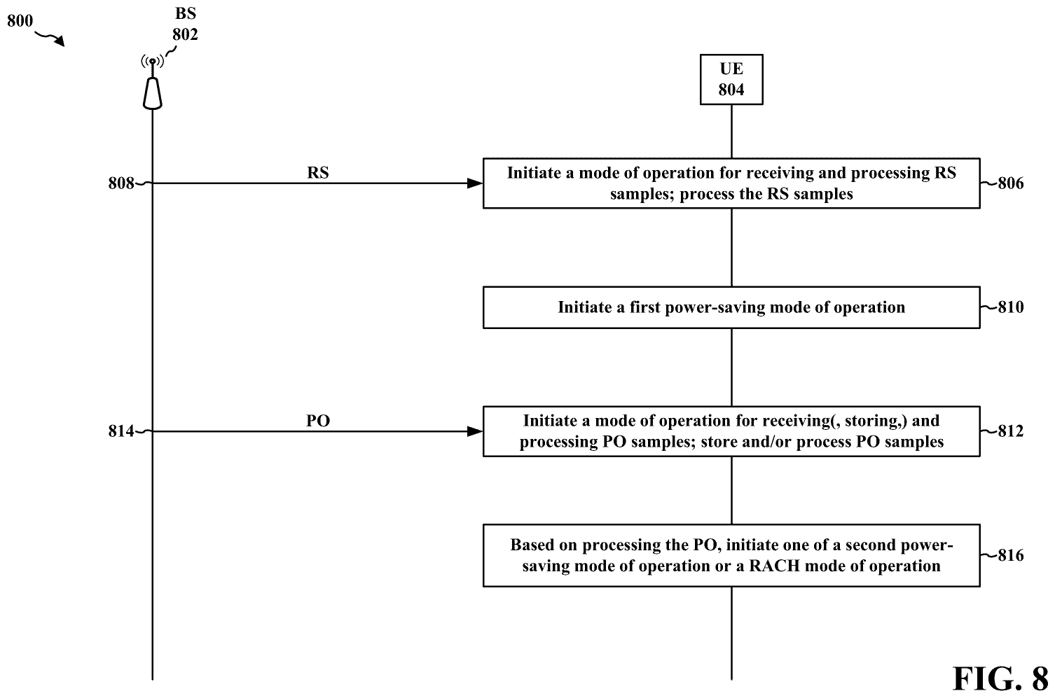

FIG. 7 is a call flow diagram 700 illustrating communication between a base station 702 and a UE 704 in a deep sleep and/or idle mode and a set of operations of the UE 704 to process samples associated with a page in accordance with some aspects of the disclosure. Diagram 700 corresponds, in large part, to the timing illustrated in diagrams 550 and 600 and will be described along with diagram 550 and 600. FIG. 8 is a call flow diagram 800 illustrating communication between a base station 802 and a UE 804 in a deep sleep and/or idle mode and a set of operations of the UE 804 to process samples associated with a page in accordance with some aspects of the disclosure. FIG. 8 corresponds, in large part, to the timing illustrated in diagrams 500 and 650 and will be described along with diagrams 500 and 650.

Generally speaking, a wireless device may have different functions and/or sets of functions that may be activated and/or deactivated independently. For example, in reference to the description of FIGS. 5-8, there may be multiple sets of functions associated with particular tasks. For example, there may be a first set of communication and/or modem functions for receiving RS samples, a second set of communication and/or modem functions for receiving PO samples (which may be the same as the first set of functions), a third set of storage and/or modem functions for storing RS and/or PO samples, a fourth set of processor and/or modem functions for processing RS samples to acquire timing and frequency information (e.g., a synchronization time and/or a synchronization frequency), a fifth set of processor and/or modem functions for processing PO samples, and a sixth set of functions in the first through fifth set of functions that are costly (e.g., in time and/or power) to deactivate and activate. A seventh set of functions for a RACH process may be activated based on a processing of PO samples.

In some aspects, a time associated with deactivating and then activating one or more functions in the sixth set of functions may be longer than a time available between a RS and a PO such that the one or more functions may not be deactivated between the RS and PO (or vice versa). In some aspects, a power consumption associated with deactivating one or more functions in the sixth set of functions after a RS (or a PO) and then activating the one or more functions for an associated PO (or an associated RS) may be greater than a power saved by deactivating the one or more functions for the time period between the RS (or PO) and the associated PO (or the associated RS) such that the one or more functions may not be deactivated between the RS and PO (or vice versa).

Diagram 500 illustrates a timing for a first set of different power saving and communication modes associated with the offline processing mode of operation. During the first time period t₁ 531, the UE (e.g., a wireless communication device) may be in a “deep sleep” and/or idle mode in which a majority of communication, or modem, functions (e.g., functions in the first through sixth sets of functions described above) are deactivated and/or inactive. At the second time period t₂ 532, the UE, in some aspects, may initiate a “wake up” operation to activate the first set of communication and/or modem functions and the third set of storage and/or modem functions for receiving and storing, or the first set of communication and/or modem functions and the fourth set of processor and/or modem functions for receiving and processing, the RS 502. The wake up, in some aspects, corresponds to initiating a mode of operation for receiving and storing the RS samples at 806 of FIG. 8. The RS 502 may be selected for processing over RS 504 based on a total time from the beginning of the first signal (RS or PO) to the end of the second signal (PO or RS, respectively) of the RS/PO (or PO/RS) pair. For example, RS 502 may be selected over RS 504 based on a time period T₁ 522 being shorter than a time period T₂ 523. RS 502, in some aspects, may correspond to RS 808 transmitted by the base station 802 and received by the UE 804. At 806, the UE 804, in some aspects, may store the RS samples associated with RS 808 (or 502).

In some aspects, after the RS 502 (or 808) has been received and the samples stored, the UE 804 may deactivate the first set of communication and/or modem functions or may deactivate functions in the first set of communication and/or modem functions that are not also in the sixth set of functions during a time period t₃ 533 between the RS 502 and the PO 511. For example, the UE may, at 810, initiate a first power-saving mode of operation (e.g., may enter into a “light sleep” or reduced function mode that consumes more power than a deep sleep and/or idle mode but less power than used when receiving and/or transmitting communications). At time period t₄ 534, the UE, in some aspects, may activate inactive and/or deactivated functions in the second set of communication and/or modem functions and the third set of storage and/or modem functions for receiving and storing the PO (e.g., the samples associated with the PO 511). For example, UE 804 may initiate, at 812, a mode of operation for receiving (and storing) and processing PO samples by activating functions in the second set of communication and/or modem functions, the third set of storage and/or modem functions, and the fifth set of processor and/or modem functions for processing PO samples for receiving (and storing) and processing PO samples. The base station 802, in some aspects, may transmit, and the UE 804 may receive, PO 814 (e.g., PO samples associated with PO 816) and store and/or process the PO samples at 812. In some aspects, the first and third sets of functions for receiving and storing the PO samples may be activated first with the fifth set of functions activated at a time after the PO samples have been received and stored for “offline” processing.

During the time period t₆ 536 the UE may deactivate active functions in the first, second, and/or third sets of functions and enter into the deep sleep and/or idle mode. Additionally, the UE may activate the fourth and/or fifth sets of functions to process the RS samples and the PO samples if not already activated. For example, the UE 804, may initiate, at 812, a mode of operation for processing the RS and PO samples by deactivating the functions in the first, second, and/or third sets of functions and activating the functions in the fourth and/or fifth sets of functions. The time period t₆ 536 may include (1) a time period t₅ 535 during which the first through third sets of functions are deactivated and the fourth and/or the fifth set of processor and/or modem functions are activated and/or are active to process the stored RS and PO samples (or continues to process remaining RS samples and/or stored PO samples) and (2) the time period t₁ 531 beginning after the UE is finished processing the RS and PO samples during which the first through fifth sets of functions are deactivated (e.g., the UE enters into the deep sleep and/or idle mode). For example, if the UE 804 determines, based on the PO processing, that no communication is expected before a next PO 512 and/or associated RS 506, the UE 804, in some aspects, may initiate a second power-saving mode of operation (e.g., a deep sleep and/or idle mode) at 816 (e.g., at the beginning of the time period t₁ 531). As described above, initiating the second power-saving mode of operation, in some aspects, may include deactivating the first through fifth sets of functions. In some aspects, if the UE 804 determines, based on the PO processing, that a communication is expected before a next PO 512 and/or associated RS 506, the UE 804, in some aspects, may initiate, at 816, a RACH mode of operation during the time period t₁ 531. For example, the RACH mode of operation may be initiated by activating the seventh set of functions. In some aspects, determining whether a communication is expected is based on the absence of a PDCCH transmission and/or based on an indication of a presence of a page in a PDSCH associated with a PDCCH transmission.

The timing illustrated in diagram 500 may lead to increased power savings compared to the timing illustrated in diagram 400. For example, assuming a same configuration of the PO period 420 and the PO period 520, the T₀ 421/521, and a RS configuration and/or timing, for each PO period 420/520, the total time in one of the light sleep (or reduced function) mode and the deep sleep (or idle) mode may be the same in diagram 400 and diagram 500 (e.g., t₁ 431 plus t₃ 433 may be equal to t₆ 536 plus t₃ 533), but the time spent in the deep sleep (or idle) mode may be greater in diagram 500 than in diagram 400 (e.g., t₆ 536 may be longer than t₁ 431). Accordingly, the power savings may be greater in diagram 500 than in diagram 400. For example, assuming (1) that the PO period is 360 ms, (2) that the sum of the time spent in the light sleep (or reduced function) mode, t_{light}, and the deep sleep (or idle) mode, t_{deep}, is 300 ms, and (3) that active communication consumes power at a rate of P (e.g., mW/ms), light sleep consumes power at a rate of 0.8 P and deep sleep consumes power at a rate of 0.2 P, a total energy usage during the PO may be given by (360−300)*P+t_{light}*0.8P+t_{deep}*0.2 P (where t_{light}=300−t_{deep}) such that the total energy may be simplified and rewritten as 300 P−t_{deep}*0.6P such that increasing time spent in the deep sleep mode (e.g., by selecting a RS that is closer in time to the PO thereby reducing a time in a light sleep mode) reduces the total energy consumed during the PO period. While the values of 0.8 P and 0.2 P may not be accurate, they illustrate the benefit gained from spending more time in a mode of operation of operation that uses less energy.

Additionally, in some aspects, the first (or second) and third set of functions activated during the time period t₂ 532 (or t₄ 534) in diagram 500 may include fewer functions than a set of functions (e.g., the first and fourth (or the second and fifth) sets of functions) that may be active and/or activated during the time period t₂ 432 (or t₄ 434) to increase the power savings during the reception of the RS 502 (or PO 511). The set(s) of functions (e.g., a minimized and/or minimal set of functions) activated during the time period t₂ 532 (or t₄ 534) may be a minimal set of functions to allow the UE to receive and store the samples associated with the RS (or PO). Accordingly, the minimized and/or minimal set of functions may not include the fourth and/or fifth set of functions for processing the RS and/or the PO in real time (and/or near real time). The fourth and/or fifth sets of functions for processing the RS and the PO may be activated after receiving and storing the samples associated with both the RS and the PO for offline and/or “batch” mode processing. In some aspects, processing the samples of the RS and the PO in the offline mode further provides power saving when compared to real time (and/or near real time) processing of the samples of the RS and then the PO.

Diagram 550 illustrates a timing for a second set of different power saving and communication modes associated with the offline processing mode of operation. During the first time period t₁ 581, the UE (e.g., a wireless communication device) may be in a “deep sleep” and/or idle mode in which a majority of communication, or modem, functions (e.g., functions in the first through sixth sets of functions described above) are deactivated and/or inactive. At the second time period t₇ 587, the UE, in some aspects, may initiate a “wake up” operation to activate the second set of communication and/or modem functions and the third set of storage and/or modem functions for receiving and storing the PO 561. The wake up, in some aspects, corresponds to initiating a mode of operation for receiving and storing the PO samples at 706 of FIG. 7. The base station 702 may transmit, and the UE 704 may receive, PO 708 and the UE 704, in some aspects, may store the PO samples associated with PO 708 (or 552) at 706.

In some aspects, after the PO 561 (or 708) has been received and the samples stored, the UE 704 may deactivate the second set of communication and/or modem functions or may deactivate functions in the first set of communication and/or modem functions that are not also in the sixth set of functions during a time period t₈ 588 between the PO 561 and the RS 554. For example, the UE may, at 710, initiate a first power-saving mode of operation (e.g., may enter into a “light sleep” or reduced function mode that consumes more power than a deep sleep and/or idle mode but less power than used when receiving and/or transmitting communications).

At time period t₉ 589, the UE, in some aspects, may activate inactive and/or deactivated functions in the first set of communication and/or modem functions and the third set of storage and/or modem functions for receiving and storing the RS 554 (e.g., the samples associated with the RS 554). For example, UE 704 may initiate, at 712, a mode of operation for receiving and storing RS samples by activating functions in the first set of communication and/or modem functions and the third set of storage and/or modem functions for receiving and storing RS samples. In some aspects, the UE may activate functions in the fourth set of functions for processing the RS samples to begin processing the RS samples as they are received, the offline nature of the processing may be preserved because the PO samples have already been stored at 708. The base station 702, in some aspects, may transmit, and the UE 704 may receive, RS 714 (e.g., RS samples associated with RS 714) and store the RS samples at 712. The RS 554 may be selected for processing over RS 552 based on a total time from the beginning of the first signal (RS or PO) to the end of the second signal (PO or RS, respectively) of the RS/PO (or PO/RS) pair. For example, RS 554 may be selected over RS 552 based on a time period T₄ 574 being shorter than a time period T₃ 573. RS 554, in some aspects, may correspond to RS 714 transmitted by the base station 702 and received by the UE 704.

During the time period t₁₀ 590 the UE may deactivate active functions in the first, second, and/or third sets of functions and enter into the deep sleep and/or idle mode. Additionally, the UE may activate the fourth and/or fifth sets of functions to process the RS samples and the PO samples if not already activated. For example, the UE 704, may initiate, at 712, a mode of operation for processing the RS and PO samples by deactivating the functions in the first, second, and/or third sets of functions and activating the functions in the fourth and/or fifth sets of functions. The time period t₁₁ 591 may include (1) a time period t₁₀ 590 during which the first through third sets of functions are deactivated and the fourth and/or the fifth set of processor and/or modem functions are activated and/or are active to process the stored RS and PO samples (or continue to process remaining RS samples and/or stored PO samples) and (2) the time period t₁ 581 beginning after the UE is finished processing the RS and PO samples during which the first through fifth sets of functions are deactivated (e.g., the UE enters into the deep sleep and/or idle mode). For example, if the UE 704 determines, based on the PO processing, that no communication is expected before a next PO 562 and/or associated RS 556, the UE 704, in some aspects, may initiate a second power-saving mode of operation (e.g., a deep sleep and/or idle mode) at 716 (e.g., at the beginning of the time period t₁ 581). As described above, initiating the second power-saving mode of operation, in some aspects, may include deactivating the first through fifth sets of functions. In some aspects, if the UE 704 determines, based on the PO processing, that a communication is expected before a next PO 562 and/or associated RS 556, the UE 704, in some aspects, may initiate, at 716, a RACH mode of operation during the time period t₁ 581. For example, the RACH mode of operation may be initiated by activating the seventh set of functions.

The timing illustrated in diagram 550 may lead to increased power savings compared to the timing illustrated in diagram 400 by increasing a time spent in a deep sleep and/or idle mode compare to a light sleep and/or reduced function mode as described in relation to diagram 500. Additionally, in some aspects, the first (or second) and third set of functions activated during the time period t₇ 587 (or t₉ 589) in diagram 550 may include fewer functions than a set of functions (e.g., the first and fourth (or the second and fifth) sets of functions) that may be active and/or activated during the time period t₂ 432 (or t₄ 434) to increase the power savings during the reception of the PO 561 (or RS 554). The set(s) of functions (e.g., a minimized and/or minimal set of functions) activated during the time period t₇ 587 (or t₉ 589) may be a minimal set of functions to allow the UE to receive and store the samples associated with the PO (or RS). Accordingly, the minimized and/or minimal set of functions may not include the fourth and/or fifth set of functions for processing the RS and/or the PO in real time (and/or near real time). The fourth and/or fifth sets of functions for processing the RS and the PO may be activated after receiving and storing the samples associated with both the RS and the PO for offline and/or “batch” mode processing. In some aspects, processing the samples of the RS and the PO in the offline mode further provides power saving when compared to real time (and/or near real time) processing of the samples of the RS and then the PO.

Diagram 600 illustrates a timing for a third set of different power saving and communication modes associated with the offline processing mode. Before the time period t₂ 632, the UE (e.g., a wireless communication device) may be in a “deep sleep” and/or idle mode in which a majority of communication and/or modem functions are deactivated and/or inactive. At the time period t₂ 632, the UE, in some aspects, may initiate a “wake up” operation to activate the second and third sets of functions for receiving and storing, the PO 611. For example, the UE 704, in some aspects, may initiate a mode of operation for receiving and storing PO samples at 706. To initiate the mode of operation for receiving and storing PO samples at 706, the UE 704 may activate the second and third sets of functions. The base station 702 may transmit, and the UE 704 may receive, a PO 708 and the UE 704 may store the PO samples at 706.

At a time t₃ 633 associated with the beginning of the RS 602, the UE may activate the first set of communication and/or modem functions for receiving and storing, or the first and fourth sets of functions for receiving and processing, the RS 602. For example, the UE 704 may initiate, at 712, a mode of operation for receiving and storing and/or receiving and processing a RS. Initiating the mode of operation for receiving and storing and/or receiving and processing a RS at 712 may include activating the first set of communication and/or modem functions for receiving and storing, or the first and fourth sets of functions for receiving and processing, an RS (e.g., RS 714). The base station 702 may transmit, and the UE 704 may receive, the RS 714. The UE 704, in some aspects, may store and/or process the samples associated with RS 714 at 712. The RS 714 may correspond to the RS 602 and may be selected for processing over RS 603 based on a total time from the beginning of the first signal (e.g., PO 611) to the end of the second signal (e.g., RS 602 or 603) of a PO and its associated RS (e.g., the RS used to acquire timing and frequency information for processing the PO). For example, RS 602 may be selected over RS 603 based on a time period T₂ 622 being shorter than a time period T₁ 621.

In some aspects, the UE may continue to obtain (e.g., receive and store) samples associated with the PO 611 while (1) initiating, at 712, the mode of operation for receiving and storing, and/or receiving and processing, the RS 714, (2) receiving the RS 714, and (3) storing and/or processing the RS samples associated with RS 714 as illustrated in diagram 600. In some aspects, at the beginning of the RS 602, the UE may receive and store samples associated with the RS 622 based on the first and/or third sets of functions. The UE in some aspects, may receive and process the samples of the RS 602 based on the first and fourth sets of functions. During the time period t₅ 635 the UE may deactivate active functions in the first, second, or third sets of functions to enter into the deep sleep and/or idle mode. For example, the UE 704 may initiate, at 712, a mode of operation for processing RS and PO samples by deactivating the first, second, and third sets of functions and activating functions in the fourth and fifth sets of functions that are not already active. The time period t₅ 635 may include (1) a time period t₄ 634 during which the first through third sets of functions are deactivated and the fourth and/or the fifth set of processor and/or modem functions are activated and/or are active to process the stored RS and PO samples (or continues to process remaining RS samples and/or stored PO samples) and (2) the time period t₁ 631 beginning after the UE is finished processing the RS and PO samples and the first through fifth sets of functions are deactivated (e.g., the UE enters into the deep sleep and/or idle mode). As illustrated, the time period t₈ 638, may be longer than the processing time T₀ 621 by an amount of time to process the samples associated with the PO. For example, if the UE 704 determines, based on the PO processing at 712, that no communication is expected before a next PO 612, the UE 704, in some aspects, may initiate a second power-saving mode of operation (e.g., a deep sleep and/or idle mode) at 716 (e.g., at the beginning of the time period t₁ 531). As described above, initiating the second power-saving mode of operation, in some aspects, may include deactivating the first through fifth sets of functions. In some aspects, if the UE 704 determines, based on the PO processing, that a communication is expected before a next PO 562, the UE 704, in some aspects, may initiate, at 716, a RACH mode of operation during the time period t₁ 531. For example, the RACH mode of operation may be initiated at 716 by activating the seventh set of functions.

The timing illustrated in diagram 600 may lead to increased power savings compared to the timing illustrated in diagram 400. For example, assuming a same configuration of (1) the PO period 420 and the PO period 620, (2) the T₀ 421/521, and (3) a RS configuration and/or timing, for each PO period 420/520, the total time in one of the light sleep (or reduced function) mode and the deep sleep (or idle) mode may be different between diagram 400 and diagram 600 (e.g., t₁ 431 plus t₃ 433 may not be equal to t₆ 636). As illustrated in diagram 600, the UE, in some aspects, may not enter into the light sleep (or reduced function) mode and may instead spend time in a communication mode (e.g., while receiving, storing and/or processing the PO 611 and the RS 602) or a deep sleep (or idle) mode of operation. As illustrated, the time spent in the deep sleep (or idle) mode may be greater in diagram 600 than in diagram 400 (e.g., t₆ 636 may be longer than t₁ 431) and the time spent in a communication mode associated with receiving, storing and/or processing the PO and the RS may be less in diagram 600 than in diagram 400. Accordingly, the power savings may be greater in diagram 600 than in diagram 400.

Additionally, in some aspects, the sets of functions (either the first through third or the first through fourth sets of functions) activated during the time period t₂ 632 in diagram 600 may include fewer functions than a set of functions activated during the time period t₂ 432 (or t₄ 434) to increase the power savings during the reception of the PO 611 and/or RS 602. The set of functions may include a minimized and/or minimal set of functions (e.g., the first through third sets of functions) to allow the UE to receive and store the samples associated with the RS (or PO) for subsequent offline processing. The minimized and/or minimal set of functions may not include the fourth set of functions for processing the RS and/or the PO in real time (and/or near real time) where the functions for processing the RS and the PO may be activated after the time period t₂ 632 for offline and/or “batch” mode processing after receiving and storing the samples associated with both the RS and the PO. In some aspects, the time period t₂ 632 includes a first time sub-period for which the minimized and/or minimal set of functions (e.g., the second and third sets of functions) are activated and a second time sub-period beginning at (or around) t₃ 633 for which additional communication and/or processing functions (e.g., the first set of functions or the first and fourth sets of functions) are activated for receiving and storing and/or receiving and processing the RS 602. The second time sub-period may begin at the same time as, or with a configured lead time and/or delay, as the RS 602 such that the processing of the RS 602 begins in real time and/or near real time and the processing of the PO samples can follow with no delay based on waiting for the PO. In some aspects, processing the samples of the RS such that there is no delay introduced by waiting for PO samples to be received further provides power saving when compared to real time (and/or near real time) processing of the samples of the RS and then the PO (e.g., as illustrated in FIG. 4). In some aspects, a mix of the “online mode” of RS and PO processing described in relation to FIG. 4 and the “offline mode” of RS and PO processing may be used by a UE to optimize power savings depending on the situation.

Diagram 650 illustrates a timing for a third set of different power saving and communication modes associated with the offline processing mode. Before the time period t₇ 687, the UE (e.g., a wireless communication device) may be in a “deep sleep” and/or idle mode in which a majority of communication and/or modem functions are deactivated and/or inactive. At the time period t₇ 687, the UE, in some aspects, may initiate a “wake up” operation to activate the first and third sets of functions for receiving and storing, and/or the second and fourth sets of functions for receiving and processing, the RS 652. For example, the UE 804, in some aspects, may initiate a mode of operation for receiving and storing, and/or receiving and processing, the RS samples at 806. To initiate the mode of operation for receiving and storing, and/or receiving and processing, the RS samples at 806, the UE 804 may activate the first and third sets of functions and/or the first and fourth sets of functions. The base station 802 may transmit, and the UE 804 may receive, a RS 808 and the UE 804 may store and/or begin processing the RS samples at 810. The RS 808 may correspond to RS 652 and may be selected for processing over RS 653 based on a total time from the beginning of the first signal (e.g., RS 652 or PO 661) to the end of the second signal (e.g., PO 661 or RS 653) of a PO and its associated RS (e.g., the RS used to acquire timing and frequency information for processing the PO). For example, RS 652 may be selected over RS 653 based on a time period T₃ 673 being shorter than a time period T₄ 674.

At a time t₆ 686 associated with the beginning of the PO 661, the UE may activate the second and third sets of functions for receiving and storing the PO 661. For example, the UE 804 may initiate, at 812, a mode of operation for receiving and storing a PO. Initiating the mode of operation for receiving and storing a PO at 812 may include activating inactive functions in the second and third sets of functions for receiving and storing PO samples (e.g., PO 814). The base station 802 may transmit, and the UE 804 may receive, the PO 814 at 812. The UE 804, in some aspects, may store the samples associated with PO 814 at 812. The PO 814 may correspond to the PO 661.

In some aspects, the UE may continue to receive and store and/or receive and process samples associated with the RS 652 while (1) initiating, at 812, the mode of operation for receiving and storing the PO 814, (2) receiving the PO 814, and (3) storing the PO samples associated with PO 814 as illustrated in diagram 650. In some aspects, at the beginning of the PO 661, the UE may receive and store samples associated with the PO 661 based on the first, second, and/or third sets of functions. The UE in some aspects, may receive and process the samples of the RS 652 based on the first and fourth sets of functions. During the time period t₉ 689 the UE may deactivate active functions in the first, second, or third sets of functions to enter into the deep sleep and/or idle mode. For example, the UE 804 may initiate, at 816, a mode of operation for processing RS and PO samples by deactivating the first, second, and third sets of functions and activating functions in the fourth and fifth sets of functions that are not already active. The time period t₉ 689 may include (1) a time period t₈ 688 during which the first through third sets of functions are deactivated and the fourth and/or the fifth set of processor and/or modem functions are activated and/or are active to process the stored RS and PO samples (or continues to process remaining RS samples and/or stored PO samples) and (2) the time period t₁ 681 beginning after the UE is finished processing the RS and PO samples and the first through fifth sets of functions are deactivated (e.g., the UE enters into the deep sleep and/or idle mode). As illustrated, the time period t₈ 688, may be longer than the processing time T₀ 621 by an amount of time to process the RS samples associated with the PO. For example, if the UE 804 determines, based on the PO processing, that no communication is expected before a next PO 662 (and/or an associated RS 654), the UE 804, in some aspects, may initiate a second power-saving mode of operation (e.g., a deep sleep and/or idle mode) at 816 (e.g., at the beginning of the time period t₁ 681). As described above, initiating the second power-saving mode of operation, in some aspects, may include deactivating the first through fifth sets of functions. In some aspects, if the UE 804 determines, based on the PO processing, that a communication is expected before a next PO 662, the UE 804, in some aspects, may initiate, at 816, a RACH mode of operation during the time period t₁ 681. For example, the RACH mode of operation may be initiated at 816 by activating the seventh set of functions.

The timing illustrated in diagram 650 may lead to increased power savings compared to the timing illustrated in diagram 400 by increasing a time spent in a deep sleep and/or idle mode compare to an active communication mode as described in relation to diagram 600. Additionally, in some aspects, the sets of functions (either the first through third or the first through fourth sets of functions) activated during the time period t₇ 687 in diagram 650 may include fewer functions than a set of functions activated during the time period t₂ 432 (or t₄ 434) to increase the power savings during the reception of the PO 661 and/or the RS 652. The set of functions may include a minimized and/or minimal set of functions (e.g., the first through third sets of functions) to allow the UE to receive and store the samples associated with the RS (or PO) for subsequent offline processing. The minimized and/or minimal set of functions may not include the fourth set of functions for processing the RS and/or the PO in real time (and/or near real time) where the functions for processing the RS and the PO may be activated after the time period t₇ 687 for offline and/or “batch” mode processing after receiving and storing the samples associated with both the RS and the PO. In some aspects, the time period t₇ 687 includes a first time sub-period for which the minimized and/or minimal set of functions (e.g., the first and third sets of functions or the first and fourth sets of functions) are activated and a second time sub-period beginning at (or around) t₆ 686 for which additional communication and/or processing functions (e.g., the second set of functions or the second and third sets of functions) are activated for receiving and storing the PO 661. The second time sub-period may begin at the same time as, or with a configured lead time and/or delay, as the PO 661 such that the processing of the RS 652 begins in real time and/or near real time and the processing of the PO samples can follow with no delay based on waiting for the PO. In some aspects, processing the samples of the RS such that there is no delay introduced by waiting for PO samples to be received further provides power saving when compared to real time (and/or near real time) processing of the samples of the RS and then the PO (e.g., as illustrated in FIG. 4). In some aspects, a mix of the “online mode” of RS and PO processing described in relation to FIG. 4 and the “offline mode” of RS and PO processing may be used by a UE to optimize power saving depending on the situation.

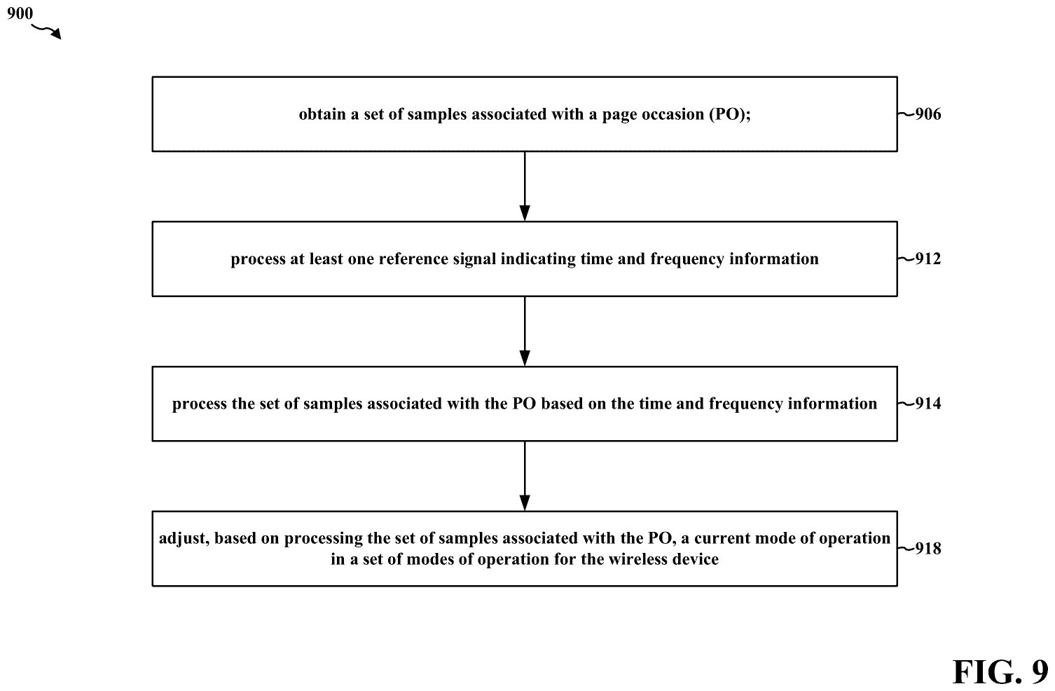

FIG. 9 is a flowchart 900 of a method of wireless communication, e.g., associated with a discontinuous reception (DRX) cycle. The method may be performed by a wireless device such as a UE (e.g., the UE 104, 704, and/or 804; the apparatus 1204). Before beginning the method illustrated in flowchart 9, the UE may operate in a first mode of operation of a set of modes of operation. The first mode of operation, in some aspects, may be a mode of operation in which a majority of modem functions of the UE are inactive. Referring to FIGS. 5-8, the first mode of operation may be a deep sleep and/or idle mode of operation (or a second power-saving mode of operation) in which the first through seventh sets of function are inactive and/or deactivated. For example, the UE may operate in the first mode of operation during one of the time periods t₁ 531/581/631/681.

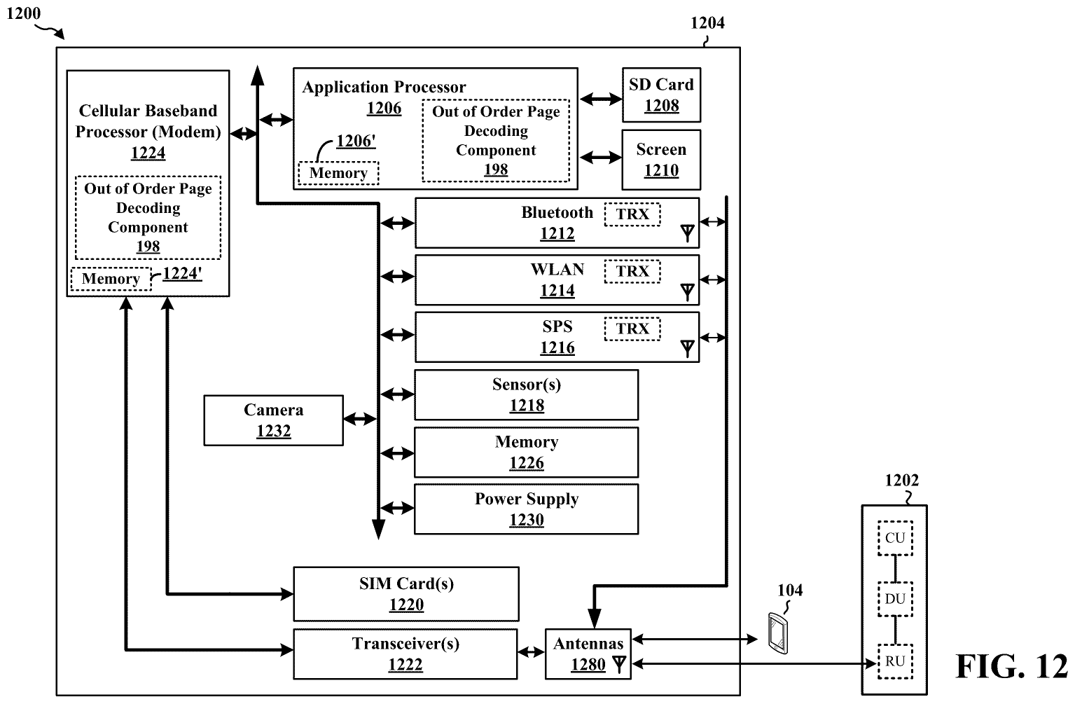

In some aspects, a PO may precede (or at least begin before) an associated RS used to acquire (or determine) time and frequency information. Alternatively, or additionally (at different times), a RS may indicate time and frequency information for a PO that follows (or at least begins after) the RS in some aspects. The UE may, at 906, obtain a set of samples associated with the PO. For example, 906 may be performed by application processor 1206, cellular baseband processor 1224, transceiver(s) 1222, antenna(s) 1280, and/or out of order page decoding component 198 of FIG. 12. In some aspects, obtaining the set of samples associated with the PO at 906 may include receiving the set of PO samples and storing the set of PO samples. For example, referring to FIGS. 5-8, the UE 704 or 804 may obtain the PO samples at 706 or 812, respectively. In some aspects, the PO and the associated RS used to acquire (or determine) time and frequency information may be transmitted in non-overlapping time periods and the UE 804 may initiate at 810 a first power-saving mode of operation (e.g., a light sleep or reduced function mode of operation) during a time between the PO 708 and the associated RS 714.

In order to obtain the PO samples at 906, the UE may activate, before the PO, a minimal set of modem functions associated with a second mode of operation of the set of modes of operation for obtaining and storing the set of samples associated with the PO. Activating the minimal set of modem functions, in some aspects, may be followed by, or be a part of, initiating the second mode of operation after activating the minimal set of modem functions. For example, referring to FIGS. 5-8, the minimal set of modem functions may include the second and third sets of functions for receiving and storing the PO (or the PO samples). The UEs 704 and 804 may initiate a mode of operation for receiving and storing PO samples at 706 and 812, respectively.

At 912, the UE may process at least one reference signal indicating time and frequency information. For example, 912 may be performed by application processor 1206, cellular baseband processor 1224, transceiver(s) 1222, antenna(s) 1280, and/or out of order page decoding component 198 of FIG. 12. In some aspects, the time and frequency information includes a synchronization time and a synchronization frequency with a network entity associated with the at least one RS. For example, referring to FIGS. 5-8, the UE 704 or 804 may process RS samples associated with RS 714 (RS 554 or RS 602) or RS 808 (RS 502 or RS 652) to identify the time and frequency information used to process the PO.

In some aspects, to receive and process the RS, the UE may activate an expanded set of modem functions for processing a received and/or stored set of RS samples and the stored set of samples associated with the PO. In some aspects, the expanded set of modem functions is activated to initiate a third mode of operation of the set of modes of operation. The UE may operate in one of the first power-saving mode of operation or the second mode of operation until activating the expanded set of modem functions. For example, referring to FIGS. 7 and 8, the UEs 704 or 804 may initiate, at 712 or at 806, a mode of operation for receiving (and storing) and processing a RS 714 or 808. Initiating, at 712 or at 806, the mode of operation for receiving (and storing) and processing a RS may include activating functions in the first, third, and fourth set of modem functions.

The RS processed at 912 may be received based on the second mode of operation. The RS, in some aspects, may include one or more of a SSB, or a TRS. Receiving the at least one reference signal may include receiving a set of RS samples (e.g., SSB samples and/or TRS samples). For example, referring to FIGS. 5-8, the UEs 704 or 804 may receive RS 714 (RS 554 or RS 602) or RS 808 (RS 502 or RS 652). In some aspects, receiving the at least one RS may include storing the received RS samples. For example, UE 804 may store RS samples at 806.

At 914, the UE may process the set of samples associated with the PO based on the time and frequency information indicated in the RS. For example, 914 may be performed by application processor 1206, cellular baseband processor 1224, and/or out of order page decoding component 198 of FIG. 12. In some aspects, before processing the set of samples associated with the PO, the UE may activate a set of functions for processing the PO samples (if not already activated). For example, referring to FIGS. 7 and 8, the UEs 704 or 804 may initiate a mode of operation for processing the RS and PO at 712 or 812, and may process the PO.

Based on the processing of the set of samples associated with the PO at 914, the UE may determine and implement an adjustment indicated by the PO at 918. For example, 918 may be performed by application processor 1206, cellular baseband processor 1224, and/or out of order page decoding component 198 of FIG. 12. The determination at 918 may be related to determining whether a communication is expected before a next PO. If the UE determines, at 918, that the set of samples associated with the PO indicates for the wireless device to operate in the first mode of operation (e.g., that the PO indicates that no communication is expected before a next PO), the UE may deactivate the expanded set of modem functions and the minimal set of modem functions to operate in the first mode of operation until a time before a next PO to adjust the current mode of operation. Referring to FIGS. 5-8, for example, the UEs 704 or 804 may initiate a second power-saving mode of operation at 716 or 816 during the time period t₁ 531/581/631/681.

If the UE determines, at 918, that the set of samples associated with the PO indicates for the wireless device to begin a RACH process (e.g., that the PO indicates that a communication is expected before a next PO), the UE may activate, at 918, a set of modem functions associated with the RACH process. Referring to FIGS. 5-8, for example, the UEs 704 or 804 may initiate a RACH mode of operation at 716 or 816 during the time period t₁ 531/581/631/681.

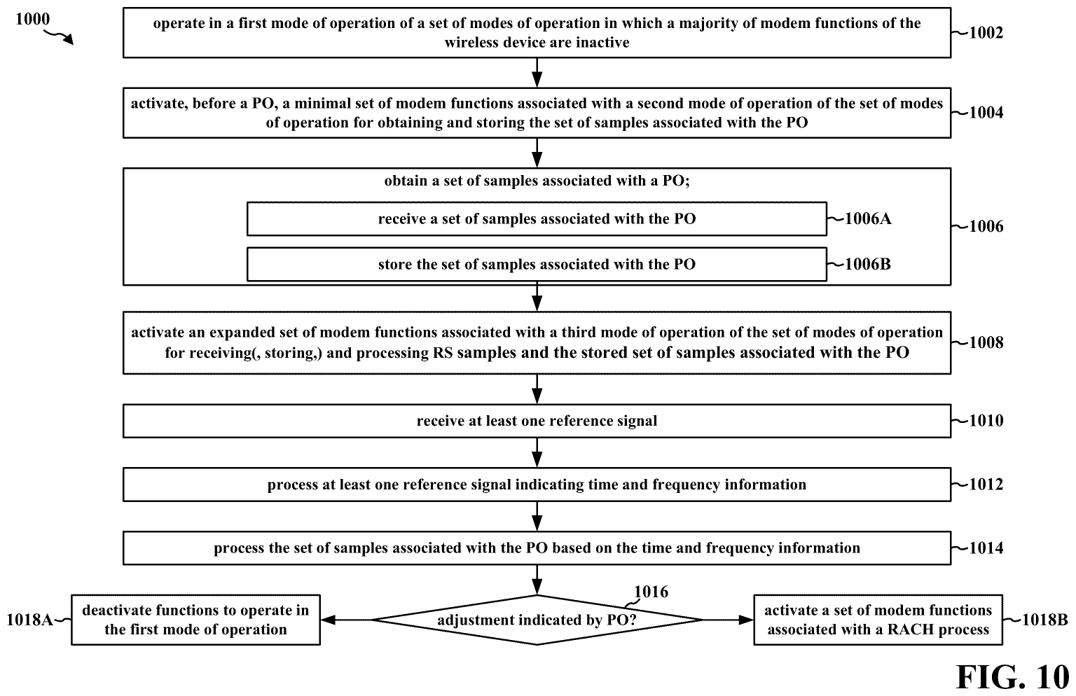

FIG. 10 is a flowchart 1000 of a method of wireless communication, e.g., associated with a DRX cycle. The method may be performed by a wireless device such as a UE (e.g., the UE 104, 704, and/or 804; the apparatus 1204). At 1002, the UE may operate in a first mode of operation of a set of modes of operation. The first mode of operation, in some aspects, may be a mode of operation in which a majority of modem functions of the UE are inactive. For example, 1002 may be performed by application processor 1206, cellular baseband processor 1224, and/or out of order page decoding component 198 of FIG. 12. Referring to FIGS. 5-7, the first mode of operation may be a deep sleep and/or idle mode of operation (or a second power-saving mode of operation) in which the first through seventh sets of function are inactive and/or deactivated. For example, the UE may operate in the first mode of operation during one of the time periods t₁ 531/581/631/681.

In some aspects, a PO may precede (or at least begin before) an associated RS used to acquire (or determine) time and frequency information. At 1004, the UE may activate, before a PO, a minimal set of modem functions associated with a second mode of operation of the set of modes of operation for obtaining and storing the set of samples associated with the PO. For example, 1004 may be performed by application processor 1206, cellular baseband processor 1224, and/or out of order page decoding component 198 of FIG. 12. Activating the minimal set of modem functions, in some aspects, may be followed by, or be a part of, initiating the second mode of operation after activating the minimal set of modem functions. For example, referring to FIGS. 5-7, the minimal set of modem functions may include the second and third sets of functions for receiving and storing the PO (or the PO samples). The UE 704 may initiate a mode of operation for receiving and storing PO samples at 706.

While operating in the second mode of operation, the UE may, at 1006, obtain a set of samples associated with the PO. For example, 1006 may be performed by application processor 1206, cellular baseband processor 1224, transceiver(s) 1222, antenna(s) 1280, and/or out of order page decoding component 198 of FIG. 12. In some aspects, obtaining the set of samples associated with the PO at 1006 may include receiving the set of PO samples at 1006A and storing the set of PO samples at 1006B. For example, referring to FIGS. 5-7, the UE 704 may receive PO 708 (PO 561 or PO 611) and store the PO samples at 706. In some aspects, the PO and the associated RS used to acquire (or determine) time and frequency information may be transmitted in non-overlapping time periods and the UE 704 may initiate at 710 a first power-saving mode of operation (e.g., a light sleep or reduced function mode of operation) during a time between the PO 708 and the associated RS 714.

At 1008, the UE may activate an expanded set of modem functions for processing a received and/or stored set of RS samples and the stored set of samples associated with the PO. For example, 1008 may be performed by application processor 1206, cellular baseband processor 1224, and/or out of order page decoding component 198 of FIG. 12. In some aspects, the expanded set of modem functions is activated to initiate a third mode of operation of the set of modes of operation. The UE may operate in one of the first power-saving mode of operation or the second mode of operation until activating the expanded set of modem functions at 1008. For example, referring to FIGS. 5-7, the UE 704 may initiate at 712, a mode of operation for receiving and storing RS samples by activating functions in the first and third sets of modem functions and/or the first and fourth sets of modem functions for receiving (and storing) and processing RS samples (e.g., of RS 714).

At 1010, the UE may receive at least one reference signal. For example, 1010 may be performed by application processor 1206, cellular baseband processor 1224, transceiver(s) 1222, antenna(s) 1280, and/or out of order page decoding component 198 of FIG. 12. The RS, in some aspects, may include one or more of a SSB, or a TRS. Receiving the at least one reference signal may include receiving a set of RS samples (e.g., SSB samples and/or TRS samples). For example, referring to FIGS. 5-7, the UE 704 may receive RS 714 (RS 554 or RS 602). In some aspects, receiving the at least one RS at 1010 may include storing the received RS samples. For example, UE 704 may store RS samples at 712.

At 1012, the UE may process at least one reference signal indicating time and frequency information. For example, 1012 may be performed by application processor 1206, cellular baseband processor 1224, and/or out of order page decoding component 198 of FIG. 12. In some aspects, the time and frequency information includes a synchronization time and a synchronization frequency with a network entity associated with the at least one RS. For example, referring to FIGS. 5-7, the UE 704 may process RS samples associated with RS 714 (RS 554 or RS 602) to identify the time and frequency information used to process the PO.

At 1014, the UE may process the set of samples associated with the PO based on the time and frequency information indicated in the RS. For example, 1014 may be performed by application processor 1206, cellular baseband processor 1224, and/or out of order page decoding component 198 of FIG. 12. In some aspects, before processing the set of samples associated with the PO, the UE may activate a set of functions for processing the PO samples (if not already activated). For example, referring to FIGS. 5-7, the UE 704 may initiate a mode of operation for processing the RS and PO at 712, e.g., by activating the fourth and fifth sets of modem functions, and may then process the PO.

Based on the processing of the set of samples associated with the PO at 1014, the UE may determine an adjustment indicated by the PO at 1016. For example, 1016 may be performed by application processor 1206, cellular baseband processor 1224, and/or out of order page decoding component 198 of FIG. 12. The determination at 1016 may be related to determining whether a communication is expected before a next PO. If the UE determines at 1016 that the set of samples associated with the PO indicates for the wireless device to operate in the first mode of operation (e.g., that the PO indicates that no communication is expected before a next PO), the UE may, at 1018A, deactivate the expanded set of modem functions and the minimal set of modem functions to operate in the first mode of operation until a time before a next PO to adjust the current mode of operation. For example, 1018A may be performed by application processor 1206, cellular baseband processor 1224, and/or out of order page decoding component 198 of FIG. 12. Referring to FIGS. 5-7, for example, the UE 704 may initiate a second power-saving mode of operation at 716 during the time period t₁ 531/581/631/681.

If the UE determines at 1016 that the set of samples associated with the PO indicates for the wireless device to begin a RACH process (e.g., that the PO indicates that a communication is expected before a next PO), the UE may, at 1018B, activate a set of modem functions associated with the RACH process. For example, 1018B may be performed by application processor 1206, cellular baseband processor 1224, and/or out of order page decoding component 198 of FIG. 12. Referring to FIGS. 5-7, for example, the UE 704 may initiate a RACH mode of operation at 716 during the time period t₁ 531/581/631/681.

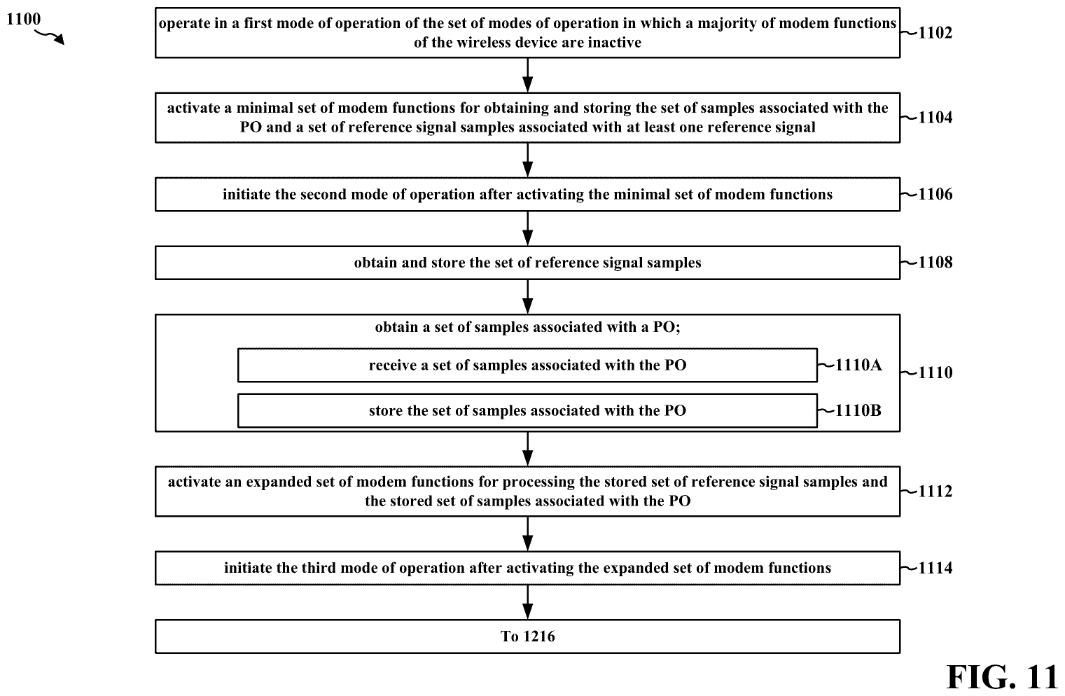

FIG. 11 is a flowchart 1100 of a method of wireless communication, e.g., associated with a DRX cycle. The method may be performed by a wireless device such as a UE (e.g., the UE 104, 704, and/or 804; the apparatus 1204). At 1102, the UE may operate in a first mode of operation of a set of modes of operation. The first mode of operation, in some aspects, may be a mode of operation in which a majority of modem functions of the UE are inactive. For example, 1102 may be performed by application processor 1206, cellular baseband processor 1224, and/or out of order page decoding component 198 of FIG. 12. Referring to FIGS. 5, 6, and 8, the first mode of operation may be a deep sleep and/or idle mode of operation (or a second power-saving mode of operation) in which the first through seventh sets of function are inactive and/or deactivated. For example, the UE may operate in the first mode of operation during one of the time periods t₁ 531/581/631/681.

In some aspects, a RS may indicate time and frequency information for a PO that follows (or at least begins after) the RS. At 1104, the UE may activate a minimal set of modem functions for obtaining (e.g., receiving) and storing the set of samples associated with the PO and a set of reference signal samples associated with at least one reference signal. In some aspects, the minimal set of modem functions is activated to initiate a second mode of operation of the set of modes of operation. Activating the minimal set of modem functions, in some aspects, may be followed by, or be a part of, initiating, at 1106, the second mode of operation after activating the minimal set of modem functions. For example, 1104 and/or 1106 may be performed by application processor 1206, cellular baseband processor 1224, and/or out of order page decoding component 198 of FIG. 12. For example, referring to FIGS. 5, 6, and 8, the minimal set of modem functions activated may include the first, second, and third sets of functions for receiving and storing the set of RS samples and receiving and storing the PO (or the PO samples). The UE 804 may initiate a mode of operation for receiving and processing the RS at 806, and a mode of operations for receiving and storing the PO samples at 812.

While operating in the second mode of operation, the UE may, at 1108, obtain and store the set of RS samples. For example, 1108 may be performed by application processor 1206, cellular baseband processor 1224, transceiver(s) 1222, antenna(s) 1280, and/or out of order page decoding component 198 of FIG. 12. Referring to FIGS. 5, 6, and 8, for example, the UE 804 may receive the RS 808 (e.g., RS samples associated with the RS 808).

While operating in the second mode of operation, the UE may, at 1110, obtain a set of samples associated with the PO. For example, 1110 may be performed by application processor 1206, cellular baseband processor 1224, transceiver(s) 1222, antenna(s) 1280, and/or out of order page decoding component 198 of FIG. 12. In some aspects, obtaining the set of samples associated with the PO at 1110 may include receiving the set of PO samples at 1110A and storing the set of PO samples at 1110B. For example, referring to FIGS. 5, 6, and 8, the UE 804 may receive PO 814 (PO 511 or PO 661) and store the PO samples at 812. In some aspects, the RS used to acquire (or determine) time and frequency information for an associated PO may be transmitted in non-overlapping time periods and the UE 804 may initiate at 810 a first power-saving mode of operation (e.g., a light sleep or reduced function mode of operation) during a time between the RS 808 and the associated PO 814.

At 1112, the UE may activate an expanded set of modem functions for processing a received and/or stored set of RS samples and the stored set of samples associated with the PO. For example, 1112 may be performed by application processor 1206, cellular baseband processor 1224, and/or out of order page decoding component 198 of FIG. 12. In some aspects, the expanded set of modem functions is activated to initiate, at 1114, a third mode of operation of the set of modes of operation. The UE may operate in the second mode of operation until activating the expanded set of modem functions at 1112 and initiating the third mode of operation at 1114. For example, 1114 may be performed by application processor 1206, cellular baseband processor 1224, and/or out of order page decoding component 198 of FIG. 12. For example, referring to FIGS. 5, 6, and 8, the UE 804 may initiate, at 806, a mode of operation for processing RS samples and may initiate, at 812, a mode of operations for processing the PO samples by activating functions in the fourth and fifth sets of modem functions for receiving processing the RS samples (e.g., RS 808) and the PO samples (e.g., PO 814), respectively. In some aspects, in addition to activating the fourth and fifth sets of modem functions, the UE 804 may deactivate the first, second, and third sets of functions as the associated transmissions (e.g., the RS or PO transmissions) are complete to initiate the third mode of operation for processing the RS and PO samples. The process may then proceed to adjust the mode of operation based on the processing of the PO (and the RS) as described in relation to 1016 and either 1018A or 1018B.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the out of order page decoding component 198 may be configured to obtain a set of samples associated with a PO; process at least one reference signal indicating time and frequency information; process the set of samples associated with the PO based on the time and frequency information; and adjust, based on processing the set of samples associated with the PO, a current mode of operation in a set of modes of operation for the wireless device. The out of order page decoding component 198 may be configured to perform any of the aspects described in connection with the flowchart in FIGS. 9-11, and/or the aspects performed by the UE in FIG. 7 or 8. The out of order page decoding component 198 may be within the cellular baseband processor 1224, the application processor 1206, or both the cellular baseband processor 1224 and the application processor 1206. The out of order page decoding component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for obtaining a set of samples associated with a PO. The apparatus 1204, and in particular the cellular baseband processor 1224 and/or the application processor 1206, may also include means for processing at least one reference signal indicating time and frequency information. The apparatus 1204, and in particular the cellular baseband processor 1224 and/or the application processor 1206, may also include means for processing the set of samples associated with the PO based on the time and frequency information. The apparatus 1204, and in particular the cellular baseband processor 1224 and/or the application processor 1206, may also include means for adjusting, based on processing the set of samples associated with the PO, a current mode of operation in a set of modes of operation for the wireless device. The apparatus 1204, and in particular the cellular baseband processor 1224 and/or the application processor 1206, may also include means for operating in a first mode of operation of the set of modes of operation in which a majority of modem functions of the wireless device are inactive. The apparatus 1204, and in particular the cellular baseband processor 1224 and/or the application processor 1206, may also include means for activating, before the PO, a minimal set of modem functions associated with a second mode of operation of the set of modes of operation for obtaining and storing the set of samples associated with the PO. The apparatus 1204, and in particular the cellular baseband processor 1224 and/or the application processor 1206, may also include means for receiving the set of samples associated with the PO. The apparatus 1204, and in particular the cellular baseband processor 1224 and/or the application processor 1206, may also include means for storing the set of samples associated with the PO, where obtaining and storing the set of samples is associated with the second mode of operation. The apparatus 1204, and in particular the cellular baseband processor 1224 and/or the application processor 1206, may also include means for activating an expanded set of modem functions associated with a third mode of operation of the set of modes of operation for receiving and processing the at least one reference signal. The apparatus 1204, and in particular the cellular baseband processor 1224 and/or the application processor 1206, may also include means for receiving the at least one reference signal prior to processing the at least one reference signal. The apparatus 1204, and in particular the cellular baseband processor 1224 and/or the application processor 1206, may also include means for deactivating the expanded set of modem functions and the minimal set of modem functions to operate in the first mode of operation until a time before a next PO. The apparatus 1204, and in particular the cellular baseband processor 1224 and/or the application processor 1206, may also include means for activating a set of modem functions associated with the RACH process, where the set of modem functions associated with the RACH process is activated to initiate a fourth mode of operation of the set of modes of operation. The apparatus 1204, and in particular the cellular baseband processor 1224 and/or the application processor 1206, may also include means for activating a minimal set of modem functions for obtaining and storing the set of samples associated with the PO and a set of reference signal samples associated with the at least one reference signal. The apparatus 1204, and in particular the cellular baseband processor 1224 and/or the application processor 1206, may also include means for initiating the second mode of operation after activating the minimal set of modem functions. The apparatus 1204, and in particular the cellular baseband processor 1224 and/or the application processor 1206, may also include means for obtaining and storing the set of reference signal samples. The apparatus 1204, and in particular the cellular baseband processor 1224 and/or the application processor 1206, may also include means for storing the set of samples associated with the PO. The apparatus 1204, and in particular the cellular baseband processor 1224 and/or the application processor 1206, may also include means for activating an expanded set of modem functions for processing the stored set of reference signal samples and the stored set of samples associated with the PO. The apparatus 1204, and in particular the cellular baseband processor 1224 and/or the application processor 1206, may also include means for initiating the third mode of operation after activating the expanded set of modem functions. The apparatus may include means for performing any of the aspects described in connection with the flowcharts in FIGS. 9-11 and/or the aspects performed by the UE in FIGS. 7 and 8. The means may be the out of order page decoding component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

In some aspects of wireless communication, a wireless communication device (e.g., a UE) may be in a power-saving mode (e.g., an idle mode such as RRC IDLE mode, or a “deep sleep”). The power saving mode may be associated with a reduced set of activated and/or a reduced set of active functions. While in the power saving mode, the activated and/or active functions of the wireless communication device may not allow the wireless communication device to receive communication from a transmitting device. Accordingly, the wireless communication device may periodically activate additional functions (e.g., perform a wake up) to detect upcoming communications. The additional functions may be associated with search, measurements, and/or loops processing for processing the reference signal and/or to decode a page associated with a PO. For example, the additional functions may be associated with a set of one or more reference signals used to acquire timing information for a subsequent PO for the wireless communication device that indicates whether a communication is scheduled before a next PO for the wireless communication device.

As discussed above, a method or apparatus may be provided that improves power saving for page occasion decoding in a DRX mode of operation. The improvement may be provided by introducing an offline mode for PO decoding in which a closest-in-time RS may be used to acquire timing and/or frequency information for a PO and samples associated with the RS and the PO may be stored for offline processing. The offline processing may allow a wireless device to increase a fraction of time spent in modes of operations that conserve more power (e.g., deep sleep instead of light sleep or active communication).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including obtaining a set of samples associated with a PO; processing at least one reference signal associated with time and frequency information; processing the set of samples associated with the PO based on the time and frequency information; and adjusting, based on processing the set of samples associated with the PO, a current mode of operation in a set of modes of operation for the wireless device.

Aspect 2 is the method of aspect 1, further including operating in a first mode of operation of the set of modes of operation in which a majority of modem functions of the wireless device are inactive; activating, before the PO, a minimal set of modem functions associated with a second mode of operation of the set of modes of operation for obtaining and storing the set of samples associated with the PO; and storing the set of samples associated with the PO, where obtaining and storing the set of samples is associated with the second mode of operation.

Aspect 3 is the method of aspect 2, further including activating an expanded set of modem functions associated with a third mode of operation of the set of modes of operation for receiving and processing the at least one reference signal, where the wireless device operates in the second mode of operation until activating the expanded set of modem functions; and receiving the at least one reference signal prior to processing the at least one reference signal, where receiving and processing the at least one reference signal is associated with the third mode of operation.

Aspect 4 is the method of aspect 3, where the at least one reference signal is received after the PO.

Aspect 5 is the method of aspect 4, where the set of samples associated with the PO indicates for the wireless device to operate in the first mode of operation, and adjusting the current mode of operation includes deactivating the expanded set of modem functions and the minimal set of modem functions to operate in the first mode of operation until a time before a next PO.

Aspect 6 is the method of aspect 4, where the set of samples associated with the PO indicates for the wireless device to begin a RACH process, and where adjusting the current mode of operation includes activating a set of modem functions associated with the RACH process.

Aspect 7 is the method of any of aspects 1 to 6, where the time and frequency information includes a synchronization time and a synchronization frequency with a network entity associated with the at least one reference signal.

Aspect 8 is the method of any of aspects 1 to 7, where the at least one reference signal is a nearest reference signal to the PO.

Aspect 9 is the method of any of aspects 1, 7, and 8, further including operating in a first mode of operation of the set of modes of operation in which a majority of modem functions of the wireless device are inactive; and activating a minimal set of modem functions for obtaining and storing the set of samples associated with the PO and a set of reference signal samples associated with the at least one reference signal, where the minimal set of modem functions is activated to initiate a second mode of operation of the set of modes of operation.

Aspect 10 is the method of aspect 9, further including initiating the second mode of operation after activating the minimal set of modem functions; obtaining and storing the set of reference signal samples; storing the set of samples associated with the PO; and activating an expanded set of modem functions for processing the stored set of reference signal samples and the stored set of samples associated with the PO, where the expanded set of modem functions is activated to initiate a third mode of operation of the set of modes of operation.

Aspect 11 is the method of aspect 10, further including initiating the third mode of operation after activating the expanded set of modem functions, where the wireless device operates in the third mode of operation while processing the at least one reference signal and the set of samples associated with the PO.

Aspect 12 is the method of aspect 10, where the set of samples associated with the PO indicates for the wireless device to operate in the first mode of operation, and adjusting the current mode of operation includes deactivating the expanded set of modem functions and the minimal set of modem functions to operate in the first mode of operation until a time before a next PO.

Aspect 13 is the method of aspect 10, where the set of samples associated with the PO indicates for the wireless device to begin a RACH process, and adjusting the current mode of operation includes activating a set of modem functions associated with the RACH process.

Aspect 14 is the method of any of aspects 1 to 13, where obtaining the set of samples associated with the PO includes receiving the set of samples associated with the PO; and storing the set of samples associated with the PO.

Aspect 15 is the method of any of aspects 1 to 14, where the set of samples is processed during a DRX cycle, and where the set of samples includes one or more page samples or one or more SSB samples.

Aspect 16 is the method of any of aspects 1 to 15, where the wireless device is a UE, and where the set of modes of operation for the wireless device include an idle mode and an inactive mode.

Aspect 17 is an apparatus for wireless communication at a device including a memory and at least one processor coupled to the memory and, based at least in part on information stored in the memory, the at least one processor is configured to implement any of aspects 1 to 16.

Aspect 18 is the apparatus of aspect 17, further including a transceiver or an antenna coupled to the at least one processor.

Aspect 19 is an apparatus for wireless communication at a device including means for implementing any of aspects 1 to 16.

Aspect 20 is a computer-readable medium (e.g., a non-transitory computer-readable medium) storing computer executable code, where the code when executed by a processor causes the processor to implement any of aspects 1 to 16.

What is claimed is:

1. An apparatus for wireless communication at a wireless device, comprising:
a memory; and
at least one processor coupled to the memory and, based at least in part on information stored in the memory, the at least one processor is configured to:
obtain a set of samples associated with a paging occasion (PO);
process at least one reference signal indicating time and frequency information;
process the set of samples associated with the PO based on the time and frequency information; and
adjust, based on processing the set of samples associated with the PO, a current mode of operation in a set of modes of operation for the wireless device.

2. The apparatus of claim 1, wherein the at least one processor is further configured to:
operate in a first mode of operation of the set of modes of operation in which a majority of modem functions of the wireless device are inactive;
activate, before the PO, a minimal set of modem functions associated with a second mode of operation of the set of modes of operation for obtaining and storing the set of samples associated with the PO; and
store the set of samples associated with the PO, wherein obtaining and storing the set of samples is associated with the second mode of operation.

3. The apparatus of claim 2, wherein the at least one processor is further configured to:
activate an expanded set of modem functions associated with a third mode of operation of the set of modes of operation for receiving and processing the at least one reference signal, wherein the wireless device operates in the second mode of operation until activating the expanded set of modem functions; and
receive the at least one reference signal prior to processing the at least one reference signal, wherein receiving and processing the at least one reference signal is associated with the third mode of operation.

4. The apparatus of claim 3, wherein the at least one reference signal is received after the PO.

5. The apparatus of claim 4, wherein the set of samples associated with the PO indicates for the wireless device to operate in the first mode of operation, and wherein to adjust the current mode of operation, the at least one processor is configured to deactivate the expanded set of modem functions and the minimal set of modem functions to operate in the first mode of operation until a time before a next PO.

6. The apparatus of claim 4, wherein the set of samples associated with the PO indicates for the wireless device to begin a random access channel (RACH) process, and wherein to adjust the current mode of operation, the at least one processor is configured to activate a set of modem functions associated with the RACH process, wherein the set of modem functions associated with the RACH process is activated to initiate a fourth mode of operation of the set of modes of operation.

7. The apparatus of claim 1, wherein the time and frequency information includes a synchronization time and a synchronization frequency with a network entity associated with the at least one reference signal.

8. The apparatus of claim 1, wherein the at least one reference signal is a nearest reference signal to the PO.

9. The apparatus of claim 1, wherein the at least one processor is further configured to:
operate in a first mode of operation of the set of modes of operation in which a majority of modem functions of the wireless device are inactive; and
activate a minimal set of modem functions for obtaining and storing the set of samples associated with the PO and a set of reference signal samples associated with the at least one reference signal, wherein the minimal set of modem functions is activated to initiate a second mode of operation of the set of modes of operation.

10. The apparatus of claim 9, wherein the at least one processor is further configured to:
initiate the second mode of operation after activating the minimal set of modem functions;
obtain and storing the set of reference signal samples;
store the set of samples associated with the PO; and
activate an expanded set of modem functions for processing the stored set of reference signal samples and the stored set of samples associated with the PO, wherein the expanded set of modem functions is activated to initiate a third mode of operation of the set of modes of operation.

11. The apparatus of claim 10, wherein the at least one processor is further configured to:
initiate the third mode of operation after activating the expanded set of modem functions, wherein the wireless device operates in the third mode of operation while processing the at least one reference signal and the set of samples associated with the PO.

12. The apparatus of claim 10, wherein the set of samples associated with the PO indicates for the wireless device to operate in the first mode of operation, and wherein to adjust the current mode of operation, the at least one processor is configured to deactivate the expanded set of modem functions and the minimal set of modem functions to operate in the first mode of operation until a time before a next PO.

13. The apparatus of claim 10, wherein the set of samples associated with the PO indicates for the wireless device to begin a random access channel (RACH) process, and wherein to adjust the current mode of operation, the at least one processor is configured to activate a set of modem functions associated with the RACH process, wherein the set of modem functions associated with the RACH process is activated to initiate a fourth mode of operation of the set of modes of operation.

14. The apparatus of claim 1, wherein to obtain the set of samples associated with the PO, the at least one processor is configured to:
receive the set of samples associated with the PO; and
store the set of samples associated with the PO.

15. The apparatus of claim 1, wherein the set of samples is processed during a discontinuous reception (DRX) cycle, and wherein the set of samples includes at least one of one or more page samples, one or more synchronization signal block (SSB) samples, or one or more tracking reference signal (TRS).

16. The apparatus of claim 1, further comprising a transceiver or an antenna coupled to the at least one processor, wherein the at least one processor is configured to obtain the set of samples associated with to PO via the transceiver or the antenna, wherein the wireless device is a user equipment (UE), and wherein the set of modes of operation for the wireless device include an idle mode and an inactive mode.

17. A method of wireless communication at a wireless device, comprising:
obtaining a set of samples associated with a paging occasion (PO);
processing at least one reference signal indicating time and frequency information;
processing the set of samples associated with the PO based on the time and frequency information; and
adjusting, based on processing the set of samples associated with the PO, a current mode of operation in a set of modes of operation for the wireless device.

18. The method of claim 17, further comprising:
operating in a first mode of operation of the set of modes of operation in which a majority of modem functions of the wireless device are inactive;
activating, before the PO, a minimal set of modem functions associated with a second mode of operation of the set of modes of operation for obtaining and storing the set of samples associated with the PO; and
storing the set of samples associated with the PO, wherein obtaining and storing the set of samples is associated with the second mode of operation.

19. The method of claim 18, further comprising:
activating an expanded set of modem functions associated with a third mode of operation of the set of modes of operation for receiving and processing the at least one reference signal, wherein the wireless device operates in the second mode of operation until activating the expanded set of modem functions; and
receiving the at least one reference signal prior to processing the at least one reference signal, wherein receiving and processing the at least one reference signal is associated with the third mode of operation.

20. The method of claim 19, wherein the at least one reference signal is received after the PO.

21. The method of claim 20,
wherein the set of samples associated with the PO indicates for the wireless device to operate in the first mode of operation, and adjusting the current mode of operation comprises deactivating the expanded set of modem functions and the minimal set of modem functions to operate in the first mode of operation until a time before a next PO; or
wherein the set of samples associated with the PO indicates for the wireless device to begin a random access channel (RACH) process, and wherein adjusting the current mode of operation comprises activating a set of modem functions associated with the RACH process, wherein the set of modem functions associated with the RACH process is activated to initiate a fourth mode of operation of the set of modes of operation.

22. The method of claim 17, wherein the at least one reference signal is a nearest reference signal to the PO and the time and frequency information includes a synchronization time and a synchronization frequency with a network entity associated with the at least one reference signal.

23. The method of claim 17, further comprising:
operating in a first mode of operation of the set of modes of operation in which a majority of modem functions of the wireless device are inactive; and
activating a minimal set of modem functions for obtaining and storing the set of samples associated with the PO and a set of reference signal samples associated with the at least one reference signal, wherein the minimal set of modem functions is activated to initiate a second mode of operation of the set of modes of operation.

24. The method of claim 23, further comprising:
initiating the second mode of operation after activating the minimal set of modem functions;
obtaining and storing the set of reference signal samples;
storing the set of samples associated with the PO; and
activating an expanded set of modem functions for processing the stored set of reference signal samples and the stored set of samples associated with the PO, wherein the expanded set of modem functions is activated to initiate a third mode of operation of the set of modes of operation.

25. The method of claim 24, further comprising:
initiating the third mode of operation after activating the expanded set of modem functions, wherein the wireless device operates in the third mode of operation while processing the at least one reference signal and the set of samples associated with the PO.

26. The method of claim 24,
wherein the set of samples associated with the PO indicates for the wireless device to operate in the first mode of operation, and adjusting the current mode of operation comprises deactivating the expanded set of modem functions and the minimal set of modem functions to operate in the first mode of operation until a time before a next PO; or
wherein the set of samples associated with the PO indicates for the wireless device to begin a random access channel (RACH) process, and adjusting the current mode of operation comprises activating a set of modem functions associated with the RACH process, wherein the set of modem functions associated with the RACH process is activated to initiate a fourth mode of operation of the set of modes of operation.

27. The method of claim 17, wherein obtaining the set of samples associated with the PO comprises:
receiving the set of samples associated with the PO; and
storing the set of samples associated with the PO.

28. The method of claim 17, wherein the set of samples is processed during a discontinuous reception (DRX) cycle, wherein the set of samples includes one or more page samples or one or more synchronization signal block (SSB) samples, wherein the wireless device is a user equipment (UE), and wherein the set of modes of operation for the wireless device include an idle mode and an inactive mode.

29. An apparatus for wireless communication at a wireless device, comprising:
means for obtaining a set of samples associated with a paging occasion (PO);
means for processing at least one reference signal indicating time and frequency information;
means for processing the set of samples associated with the PO based on the time and frequency information; and
means for adjusting, based on processing the set of samples associated with the PO, a current mode of operation in a set of modes of operation for the wireless device.

30. A computer-readable medium storing computer executable code at a wireless device, the computer executable code when executed by a processor causes the processor to:
obtain a set of samples associated with a paging occasion (PO);
process at least one reference signal indicating time and frequency information;
process the set of samples associated with the PO based on the time and frequency information; and
adjust, based on processing the set of samples associated with the PO, a current mode of operation in a set of modes of operation for the wireless device.
